(19) United States
(12) Patent Application Publication
(10) Pub. No.: US 2025/0290750 A1
(43) Pub. Date: Sep. 18, 2025

(54) Multi-Sensor Round Robin Sensing

(71) Applicant: InvenSense, Inc., San Jose, CA (US)

(72) Inventors: Vadim Tsinker, Belmont, CA (US); Federico Mazzarella, Binasco (IT)

(21) Appl. No.: 18/429,833

(22) Filed: Feb. 1, 2024

Related U.S. Application Data
(60) Provisional application No. 63/462,366, filed on Apr. 27, 2023.

(51) Int. Cl. G01C 19/5712; G01P 15/08

(52) U.S. Cl. CPC G01C 19/5712; G01P 15/08

(57) ABSTRACT

A round robin MEMS sensor system includes multiple sensor types connected to a shared sense path in which measurement and evaluation operations are performed in a round robin fashion. Signals corresponding to movement of a proof mass are selectively provided to measurement circuitry, and in turn, the output of the measurement circuitry is selectively provided to the evaluation circuitry. The timing of these operations is optimized such that numerous MEMS sensor and other sensor outputs can be evaluated through the common sense path without sacrificing sensor accuracy or speed.

### CROSS REFERENCE TO RELATED APPLICATIONS

The present application claims the benefit of U.S. Provisional Patent Application No. 63/462,366, filed Apr. 27, 2023, and entitled “6-axis Round Robin Sensing System,” which is incorporated herein in its entirety.

### BACKGROUND

Numerous items such as smart phones, smart watches, tablets, automobiles, aerial drones, appliances, aircraft, exercise aids, and game controllers may utilize sensors such as microelectromechanical system (MEMS) sensors during their operation. In many applications, various types of motion sensors such as accelerometers and gyroscopes may be analyzed independently or together in order to determine varied information for particular applications. For example, gyroscopes and accelerometers may be used in gaming applications (e.g., smart phones or game controllers) to capture complex movements by a user, drones and other aircraft may determine orientation based on gyroscope measurements (e.g., roll, pitch, and yaw), and vehicles may utilize measurements for determining direction (e.g., for dead reckoning) and safety (e.g., to recognizing skid or roll-over conditions).

MEMS devices are often implemented in multi-sensor packages, for example, including multiple MEMS accelerometers (e.g., each sensing linear acceleration along a particular axis) and multiple MEMS gyroscopes (e.g., each sensing angular velocity about a particular axis). For example, a “6-axis” sensor may sense linear acceleration along each of an x-axis, y-axis, and z-axis, as well as angular velocity about each of the x-axis, y-axis, and z-axis. In some instances, combinations of the outputs from these multiple sensors may be utilized to measure complex movements. Providing multiple sensors within a single chip facilitates efficiency in that only a single chip needs to be assembled with the end-use device to provide complex three-dimensional motion sensing.

### SUMMARY

In an embodiment of the present disclosure, a method for processing MEMS sensor outputs from multiple MEMS sensor types on shared processing circuitry comprises receiving, by a measurement circuit during at least some of an active gyroscope guard band interval, an accelerometer output signal corresponding to movement of an accelerometer proof mass of a MEMS accelerometer. The method further comprises generating, by the measurement circuit during the active gyroscope guard band interval based on the received accelerometer output signal, an analog linear acceleration signal, receiving, by an evaluation circuit during a portion of the active gyroscope guard band interval, the analog linear acceleration signal, and determining, by the evaluation circuit, a digital linear acceleration signal based on the received analog linear acceleration signal. The method further comprises receiving, by the measurement circuit during a first gyroscope measurement interval after the active gyroscope guard band interval, a gyroscope output signal corresponding to movement of a gyroscope proof mass of a MEMS gyroscope. The method further comprises providing, to the measurement circuit during an inactive gyroscope guard band interval after the first gyroscope measurement interval, a gyroscope guard band signal that does not modify an analog angular velocity signal of the measurement circuit during the inactive gyroscope guard band interval. The method further comprises receiving, by the measurement circuit during a second gyroscope measurement interval after the inactive gyroscope guard band interval, the gyroscope output signal, and generating, by the measurement circuit based on the gyroscope output signal received during the first and second gyroscope measurement intervals, the analog angular velocity signal. The method further comprises receiving, by the evaluation circuit during a portion of the second gyroscope measurement interval, the analog angular velocity signal, and determining, by the evaluation circuit, a digital angular velocity signal based on the received analog angular velocity signal.

In an embodiment of the present disclosure, a method for processing MEMS sensor outputs from a 3-axis MEMS accelerometer and a 3-axis MEMS gyroscope on shared processing circuitry comprises receiving, by a measurement circuit during a first portion of an active gyroscope guard band interval, a first accelerometer output signal corresponding to movement of a first accelerometer proof mass of a MEMS accelerometer along a first axis. The method further comprises generating, by the measurement circuit during the first portion of the active gyroscope guard band interval based on the received first accelerometer output signal, a first analog linear acceleration signal. The method further comprises receiving, by an evaluation circuit during part of the first portion of the active gyroscope guard band interval, the first analog linear acceleration signal, determining, by the evaluation circuit, a first digital linear acceleration signal from the first analog linear acceleration signal, receiving, by the measurement circuit during a second portion of the active gyroscope guard band interval, a second accelerometer output signal corresponding to movement of a second accelerometer proof mass of the MEMS accelerometer along a second axis, and generating, by the measurement circuit during the second portion of the active gyroscope guard band interval based on the received second accelerometer output signal, a second analog linear acceleration signal. The method further comprises receiving, by the evaluation circuit during part of the second portion of the active gyroscope guard band interval, the second analog linear acceleration signal and determining, by the evaluation circuit, a second digital linear acceleration signal from the second analog linear acceleration signal. The method further comprises receiving, by the measurement circuit during a third portion of the active gyroscope guard band interval, a third accelerometer output signal corresponding to movement of a third accelerometer proof mass of the MEMS accelerometer along a third axis and generating, by the measurement circuit during the third portion of the active gyroscope guard band interval based on the received third accelerometer output signal, a third analog linear acceleration signal. The method further comprises receiving, by the evaluation circuit during part of the third portion of the active gyroscope guard band interval, the third analog linear acceleration signal and determining, by the evaluation circuit, a third digital linear acceleration signal from the third analog linear acceleration signal. The method further comprises receiving, by the measurement circuit during a first gyroscope measurement interval after the active gyroscope guard band interval, a gyroscope output signal corresponding to movement of a gyroscope proof mass of a first axis of a MEMS gyroscope. The method further comprises providing, to the measurement circuit during an inactive gyroscope guard band interval after the first gyroscope measurement interval, a gyroscope guard band signal that does not modify an analog angular velocity signal of the measurement circuit inactive gyroscope guard band interval, wherein the active gyroscope guard band interval is a same amount of time as the inactive gyroscope guard band interval. The method further comprises receiving, by the measurement circuit during a second gyroscope measurement interval after the inactive gyroscope guard band interval, the gyroscope output signal, generating, by the measurement circuit based on the gyroscope output signal received during the first and second gyroscope measurement intervals, the analog angular velocity signal, and receiving, by the evaluation circuit during a portion of the second gyroscope measurement interval, the analog angular velocity signal. The method further comprises determining, by the evaluation circuit, a digital angular velocity signal based on the received analog angular velocity signal.

In an embodiment of the present disclosure, a method for processing MEMS sensor outputs from a MEMS gyroscope and at least one other MEMS sensor on shared processing circuitry comprises receiving, during a first gyroscope measurement interval, a gyroscope output signal corresponding to movement of a gyroscope proof mass, wherein the first gyroscope measurement interval includes a first peak transition during a period of the gyroscope output signal. The method further comprises receiving, during an inactive gyroscope guard band interval following the first gyroscope measurement interval, a first guard signal, wherein the inactive gyroscope guard band interval includes a first zero crossing during the period of the gyroscope output signal. The method further comprises receiving, during a second gyroscope measurement interval following the inactive gyroscope guard band interval, the gyroscope output signal, wherein the second gyroscope measurement interval includes a second peak transition during the period of the gyroscope output signal. The method further comprises receiving, during an active gyroscope guard band interval following the second gyroscope measurement interval, an output signal of the at least one other MEMS sensor, wherein the active gyroscope guard band interval includes a second zero crossing during the period of the gyroscope output signal. The method further comprises determining, based on the received gyroscope output signal during the first gyroscope measurement interval and the second gyroscope measurement interval, an angular velocity of the MEMS gyroscope and determining, based on the output signal of the at least one other MEMS sensor during a portion of the active gyroscope guard band interval, an output value for the at least one other MEMS sensor.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative MEMS system in accordance with an embodiment of the present disclosure;

FIG. 2 depicts an exemplary six-axis round robin MEMS sensor in accordance with an embodiment of the present disclosure;

FIG. 3 depicts exemplary timing diagrams of measurement and evaluation stages for a six-axis round robin MEMS sensor in accordance with an embodiment of the present disclosure;

FIG. 4 depicts an exemplary six-axis round robin MEMS sensor with gyroscope drive sense measurement in accordance with an embodiment of the present disclosure;

FIG. 5 depicts exemplary timing diagrams of measurement and evaluation stages for a six-axis round robin MEMS sensor with drive sense measurement in accordance with an embodiment of the present disclosure;

FIG. 6 depicts an exemplary six-axis round robin MEMS sensor with gyroscope drive sense and quadrature measurement in accordance with an embodiment of the present disclosure;

FIG. 7 depicts exemplary timing diagrams of measurement and evaluation stages for a six-axis round robin MEMS sensor with drive sense measurement and quadrature measurement in accordance with an embodiment of the present disclosure;

FIG. 8 depicts exemplary steps of determining a timing sequence for measurement and evaluations phases of a round robin MEMS sensor in accordance with an embodiment of the present disclosure; and

FIG. 9 depicts exemplary steps of operating a round robin MEMS sensor in accordance with an embodiment of the present disclosure.

### DETAILED DESCRIPTION

In embodiments of the present disclosure, multiple sensor types and sensor axes may share common processing circuitry in a round robin fashion, substantially reducing the area and power consumption of the overall combined sensor. For example, a 3-axis MEMS accelerometer may include one or more suspended spring-mass systems that include proof masses that are configured to move in response to a linear acceleration along a particular axis of interest, such as an x-axis accelerometer proof mass, y-axis accelerometer proof mass, and z-axis accelerometer proof mass. An exemplary 3-axis MEMS gyroscope may include one or more suspended spring-mass systems that include proof masses that move along an axis in response to a Coriolis force generated by an angular velocity about an axis that is perpendicular to the axis of proof mass movement, resulting in gyroscope proof masses that translate along each of an x-axis, y-axis, and z-axis. These proof mass movements are sensed such as by differential capacitive sensing, wherein the suspended spring-mass systems are configured such that each movement of a proof mass towards or away from a capacitive sense electrode corresponds to an equal and opposite movement of the same proof mass or an interconnected proof mass relative to another capacitive sense electrode. Each axis of each sensor thus has its own output signal (e.g., a differential accelerometer output signal or a differential gyroscope output signal) corresponding to proof mass movement of the particular sensor axis and type.

These accelerometer output signals and gyroscope output signals are processed by shared processing circuitry based on the respective frequency and phase of the output signals. For example, accelerometer output signals may typically be modulated by a “drive” or carrier signal that electrically modulates the relatively low frequency linear acceleration signal at frequency, while gyroscope output signals have a frequency and a phase that is based on a periodic physical drive motion applied to a drive system connected to the proof mass (or indirectly to the proof mass), which in turn couples to the angular velocity to cause the Coriolis force, which will typically be at a different (e.g., substantially lower) frequency than the drive signal that is seen by the sense capacitors as a periodic carrier signal. Although in many systems the accelerometer axes may have a common carrier frequency and the gyroscope axes a common drive frequency, in some embodiments some of the sensor axes of a common sensor type may have different frequencies (e.g., based on end-use applications requiring different sense precision, accuracy, bandwidth, etc.). The respective phases of each axis of the accelerometer output signals and each axis of the gyroscope output signals may be known and/or in some embodiments (e.g., multi-axis proof mass configurations on a common suspended spring-mass system) may be electrically and/or mechanically configured to be aligned or at predetermined phase delays with respect to each other.

This known phase and frequency information is utilized to schedule access to processing circuitry, such as measurement circuitry that converts the analog output signals due to proof mass movement to a signal suitable for evaluation, such as by amplifying and integrating the output signal over one or more periods of the drive/carrier signal. Switching circuitry such as a multiplexer selectively provides one of the output signals from one of the sensor axes to the measurement circuitry, although in some embodiments multiple sets of measurement circuitry may be utilized. The measurement circuitry is prepared to receive each new output signal, such as by resetting measurement circuitry components such that any residue signal from the previously processed output signal is removed from the measurement circuitry. The output of the measurement circuitry is an analog signal that is passed to the evaluation circuitry such as an ADC. Once the evaluation circuitry has received the analog output signal for a necessary time period (e.g., to perform multiple “coarse” and “fine” measurements of the analog signal), the switching circuitry can coordinate providing the next axis to the measurement circuitry while the evaluation circuitry completes its digital evaluation of the previously received signal. This may continue and be scheduled in an appropriate manner such that each sensor axis is measured frequently, such as once every cycle or few cycles. For example, in an example of accelerometers having a significantly higher carrier frequency (e.g., 12 times) than the gyroscope drive frequency, all three accelerometer axes may be evaluated once for every gyroscope axis measurement, interspersed between gyroscope axis measurement time periods during “active” gyroscope guard band intervals between gyroscope axes measurement where the gyroscope output signal is not measured. As described herein, “inactive” gyroscope guard band intervals are also provided between measurement intervals for each gyroscope axis. These gyroscope guard band intervals are generally located at and about zero-crossings of the gyroscope output signals, which prevents capture and measurement of harmonics from impacting gyroscope output measurement.

In addition, other sensor outputs may be provided to common evaluation circuitry, such as via additional switching circuitry such as a multiplexer. As an example, rather than having a different ADC evaluate low frequency ancillary signals such as temperature signals or packaging stress measurements, these signals may occasionally be provided to the evaluation circuitry while it is not evaluating an inertial sensor output signals. Other sensor-related signals may also be provided to the shared evaluation circuitry where time is available at the ADC. Drive sense electrodes may output a signal based on a drive movement of MEMS gyroscope such as to provide a closed-loop drive control to maintain a desired drive characteristic (e.g., amplitude, frequency, phase). Separate measurement circuitry may generate an analog output for this drive signal, which in turn may be provided to the shared evaluation circuitry. As another example, a quadrature signal may be extracted from the gyroscope sense signals such as to modify system characteristics (e.g., capacitances present at the C2V input nodes) to remove as much quadrature and offset as possible. Certain components of the measurement circuitry (e.g., a mixer and an integrator) may be duplicated to allow an integration of the quadrature signal simultaneously with integration of the Coriolis signal. The analog integrated quadrature signal may be provided to the evaluation circuitry at an appropriate break in the processing of inertial sensor outputs. As another example, even the “inactive” gyroscope guard bands may be used to evaluate other outputs on the shared measurement circuitry, for example, by digitally evaluating and storing the output during a first measurement interval for the gyroscope axis, utilizing the shared measurement circuitry for evaluation of the other sensor output during the inactive gyroscope guard band interval, returning to measurement and evaluation of the gyroscope axis output during the subsequent measurement interval, and evaluating and combining this latter gyroscope output measurement with the previously evaluated and stored gyroscope measurement.

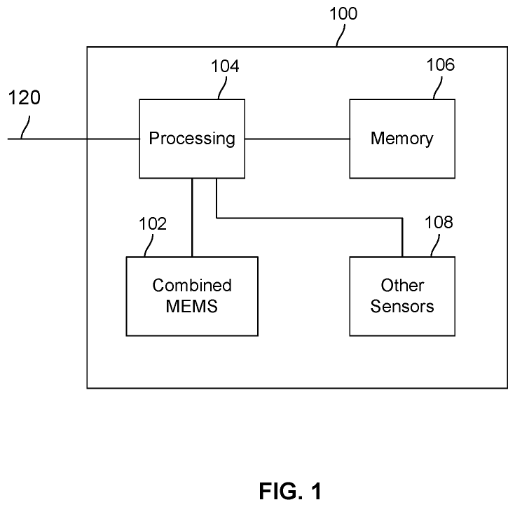

FIG. 1 shows an illustrative MEMS system 100 in accordance with an embodiment of the present disclosure. Although particular components are depicted in FIG. 1, it will be understood that other suitable combinations of MEMS and other sensors, processing components, memory, and other circuitry may be utilized as necessary for different applications and systems. In accordance with the present disclosure, the MEMS system may include a combined MEMS sensor 102 (e.g., a 3-axis MEMS accelerometer and a 3-axis MEMS gyroscope within a single “6-axis” chip or package, although other sensors and numbers of axes may combine to form a combined MEMS sensor, and multiple sensors may in some embodiments be located on adjacent chips or substrates and communicate such as via interconnects or wirebonds) as well as additional sensors 108. Although the present disclosure will be described in the context of providing round robin processing of signals received from MEMS inertial sensors and related sensors (e.g., temperature sensors, drive sense, etc.), it will be understood that the area-and-power saving enabled by the round robin processing may be utilized by other MEMS sensors that have a periodic sense waveform (e.g., a drive or carrier waveform) as well as for other related signals for such MEMS sensors (e.g., drive sense, temperature, proximity, etc.).

Processing circuitry 104 may include one or more components providing processing based on the requirements of the MEMS system 100. In some embodiments, processing circuitry 104 may include hardware control logic that may be integrated within a chip of a sensor (e.g., on a base substrate of a combined MEMS sensor 102 or other sensors 108, or on an adjacent portion of a chip to the combined MEMS sensor 102 or other sensors 108) to control the operation of the combined MEMS sensor 102 or other sensors 108 and perform aspects of processing for the combined MEMS sensor 102 or the other sensors 108. In some embodiments, the combined MEMS sensor 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the combined MEMS sensor 102 by interacting with the hardware control logic and processing signals received from combined MEMS sensor 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”).

Although in some embodiments (not depicted in FIG. 1), the combined MEMS sensor 102 or other sensors 108 may communicate directly with external circuitry (e.g., via a serial bus or direct connection to sensor outputs and control inputs), in an embodiment the processing circuitry 104 may process data received from the combined MEMS sensor 102 and other sensors 108 and communicate with external components via a communication interface 110 (e.g., a serial peripheral interface (SPI) or I2C bus, in automotive applications a controller area network (CAN) or Local Interconnect Network (LIN) bus, or in other applications a suitably wired or wireless communications interface as is known in the art). The processing circuitry 104 may convert signals received from the combined MEMS sensor 102 and other sensors 108 into appropriate measurement units (e.g., based on settings provided by other computing units communicating over the communication interface 110) and perform more complex processing to determine measurements such as orientation or Euler angles, and in some embodiments, to determine from sensor data whether a particular activity (e.g., walking, running, braking, skidding, rolling, etc.) is taking place. In some embodiments, some or all of the conversions or calculations may take place on the hardware control logic or other on-chip processing of the combined MEMS sensor 102 or other sensors 108.

In some embodiments, certain types of information may be determined based on data from multiple MEMS sensors (e.g., of the combined MEMS sensor 102) in a process that may be referred to as sensor fusion. By combining information from a variety of sensors it may be possible to accurately determine information that is useful in a variety of applications, such as image stabilization, navigation systems, automotive controls and safety, dead reckoning, remote control and gaming devices, activity sensors, 3-dimensional cameras, industrial automation, and numerous other applications. In accordance with the present disclosure, multi-axis and multi-sensor packages may utilize shared processing circuitry paths for processing the sensor outputs, resulting in substantial savings in area and power consumption without a sacrifice in sensor accuracy.

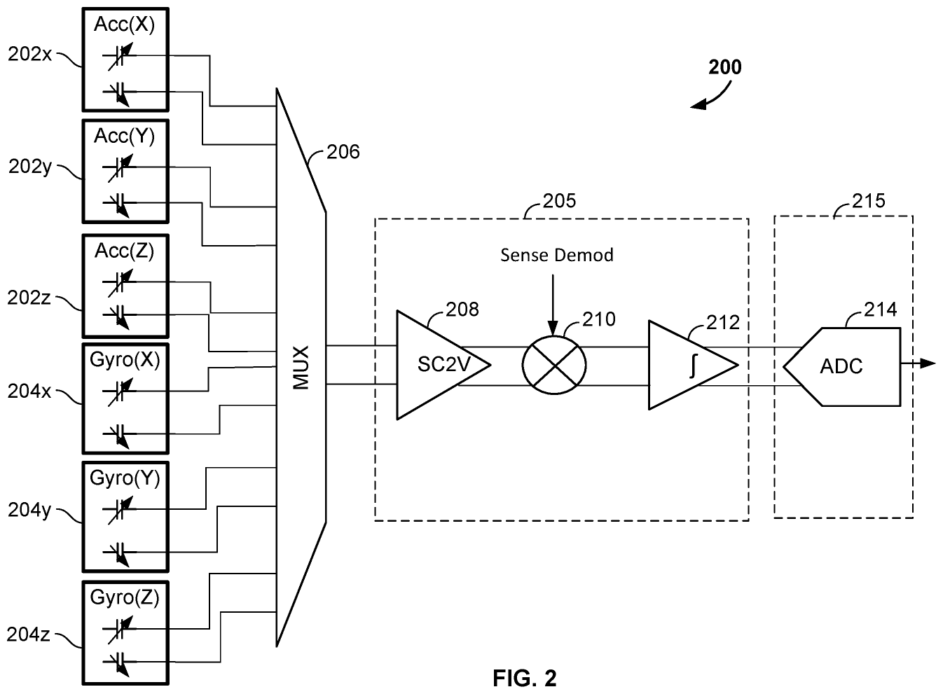

FIG. 2 depicts an exemplary six-axis round robin MEMS sensor in accordance with an embodiment of the present disclosure. Although FIG. 2 will be described in the context of a particular application and system components, it will be understood that the present disclosure may be utilized with a variety of MEMS sensor configurations and in combination with non-MEMS sensors. Although particular components are depicted and described in FIG. 2, it will be understood that components may be added, removed, substituted, or modified in accordance with the present disclosure. For example, the drawings and schematics depicted herein (e.g., FIGS. 2, 4, and 6) depict simplified versions of processing circuitry such as multiplexer 206, measurement circuitry 205, evaluation circuitry 215, sense capacitance-to-voltage (“SC2V”) amplifier 208, mixer/demodulator 210, integrator 212, and analog-to-digital converter (“ADC”) 214, and it will be understood that each of these components may be configured in a variety of manners as is understood in the art, for example, with associated resistors, capacitors, filters, switches, and the like to provide for appropriate complex signal processing and filtering. Moreover, the operations performed by particular components of processing circuitry herein may similarly be performed by alternative circuitry or components known in the art.

In the embodiment depicted in FIG. 2, a six-axis MEMS sensor 200 includes 3 axes of sensing for linear acceleration and 3 axes for sensing of angular velocity. For example, a three-axis MEMS accelerometer may include a suspended spring-mass system of an X-axis accelerometer 202x that outputs an x-axis accelerometer output signal corresponding to a capacitance due to an x-axis linear acceleration causing movement of one or more proof masses relative to one or more fixed electrodes, a suspended spring-mass system of a y-axis accelerometer 202y that outputs a y-axis accelerometer output signal corresponding to a capacitance due to a y-axis linear acceleration causing movement of one or more proof masses relative to one or more fixed electrodes, and a suspended spring-mass system of a z-axis accelerometer 202z that outputs a z-axis accelerometer output signal corresponding to a capacitance due to a z-axis linear acceleration causing movement of one or more proof masses relative to one or more fixed electrodes. In some embodiments some components of the suspended spring-mass system for each axis may be shared between axes. Each of the MEMS accelerometer axes may have a drive or carrier signal that is electrically transmitted through the suspended spring-mass system of the MEMS accelerometer at a frequency to function as a carrier signal that modulates the changing capacitance due to linear acceleration. In some implementations each of the MEMS accelerometers may have a carrier signal at a common fixed frequency, although in some embodiments different accelerometer axes may have different frequencies and/or a carrier signal may have a more complex pattern (e.g., with a frequency that changes over time). The drive/carrier frequency can be demodulated by providing a delayed version (e.g., based on a propagation delay of the MEMS structure and associated receive circuitry) of the drive/carrier signal to a mixer/demodulator (e.g., mixer/demodulator 210).

A three-axis MEMS gyroscope may include a suspended spring-mass system of an X-axis gyroscope 204x that outputs an x-axis gyroscope output signal corresponding to a capacitance due to an angular velocity about the x-axis causing movement of one or more proof masses relative to one or more fixed electrodes, a suspended spring-mass system of an Y-axis gyroscope 204y that outputs a y-axis gyroscope output signal corresponding to a capacitance due to an angular velocity about the y-axis causing movement of one or more proof masses relative to one or more fixed electrodes, and a suspended spring-mass system of an z-axis gyroscope 204z that outputs a z-axis gyroscope output signal corresponding to a capacitance due to an angular velocity about the z-axis causing movement of one or more proof masses relative to one or more fixed electrodes. In some embodiments, components such as drive masses, springs, and lever arms may be implemented in a single suspended spring-mass system implementing all three gyroscope axes. Each of the MEMS gyroscope axes may have a drive signal (e.g., a common drive motion for all three axes) that imparts a drive motion on one or more components of the respective spring-mass system that in turn couples with the angular velocity about the axis of interest to cause a Coriolis force that causes a movement of the one or more proof masses relative to the one or more fixed electrodes at the drive frequency and that is proportional to the angular velocity. The gyroscope output signal thus includes the Coriolis signal corresponding to the angular velocity to be sensed modulated by the drive frequency, which is typically much higher than a typical frequency of a sensed angular velocity. In some implementations each of the MEMS gyroscopes may have a drive signal at a common fixed frequency and phase (e.g., on a three-axis gyroscope in which all gyroscope axes are coupled to each other via springs, lever arms, etc.), although in some embodiments different gyroscope axes may have unique drive signals having different drive frequencies and/or a drive signal may have a more complex pattern, e.g., with a frequency that changes over time and can be demodulated by providing a delayed version (e.g., based on a propagation delay of the MEMS structure and associated receive circuitry) of the changing signal to a mixer/demodulator (e.g., mixer/demodulator 210).

A relative timing of the accelerometer drive/carrier signal and gyroscope drive/sense signal may be known and used by switching circuitry such as a multiplexer 206 to selectively provide outputs from particular sensor axes to processing circuitry for further processing. In an example, each of the MEMS accelerometer axes 202x-202z may have a common drive/carrier signal phase and frequency and each of the MEMS gyroscope axes 204x-204z may have a common gyroscope drive/sense phase and frequency. Further, the relationships between the MEMs accelerometer phase/frequency and the MEMS gyroscope phase/frequency may be known, for example, with the MEMS gyroscope period an integer multiple of the MEMS accelerometer period. In other more complex implementations, differing frequencies and phases may be known and/or monitored. However the relative frequency and phase information is obtained, this information may be used to selectively provide one of the output signals from MEMS accelerometer axes 202x-202z or MEMS gyroscope axes 204x-204z for processing via multiplexer 206.

Although a multiplexer 206 is depicted as selectively providing one of the outputs of MEMS accelerometer axes 202x-202z or MEMS gyroscope axes 204x-204z to the measurement circuitry 205, it will be understood that a variety of switching hardware and/or techniques may be used to selectively switch MEMS sensor axis output signals (e.g., differential sense signal) to other processing circuitry. The timing of the multiplexer selectively providing output signals to the processing circuitry is controlled such as a by a control signal (not depicted in FIG. 2) provided based on the timing described herein. For example, timing control of multiplexer 206 may be performed such that higher frequency signals (e.g., accelerometer output signals) are processed in sequence between lower frequency signals (e.g., gyroscope output signals) and such that particular portions of the output signals (e.g., corresponding to all or a portion of one or more periods) are provided for further processing.

Measurement circuitry 205 processes a received output signal from one of the MEMS sensor axis outputs to generate an analog output signal representative of the sensed signal of interest, such as linear acceleration along an axis or angular velocity about an axis. Although generating the analog signal may be performed in a variety of manners, as depicted in FIG. 2, measurement circuitry 205 includes sense C2V amplifier 208, demodulator 210, and integrator 212. Sense C2V amplifier 208 receives the differential output signal that is selectively output by multiplexer 208 and amplifies the signal, and in some embodiments assists in filtering out undesirable signal components such as an offset or quadrature input (e.g., based on selectively applied input circuitry). The amplified output of sense C2V amplifier is provided to mixer/demodulator 210 which applies a phase-aligned demodulation signal having the frequency of the signal being measured, for example, based on a known timing and frequency of the MEMS sensor type and axis being measured. The resulting demodulated output signal (e.g., corresponding to linear acceleration or Coriolis force/angular velocity) is provided to integrator 212 which integrates the received signal over an appropriate time period (e.g., one or more periods of the underlying drive or carrier signal or particular portions thereof), with the integrated signal corresponding to the respective output signal (e.g., the analog linear acceleration signal or the analog angular velocity signal, as appropriate).

Control signals may control the particular configuration and operation of components of the measurement circuitry 205 based on the signal being provided via multiplexer 206 and the timing of that signal. For example, during or shortly before the switching by multiplexer 206 of another axis or MEMS sensor type (e.g., of MEMS sensor axes 202x-202z and 204x-204z) to connect to measurement circuit 205, certain components such as C2V amplifier 208 and integrator 212 may be reset (e.g., by creating a short between input and output terminals of these components) and an updated sense demodulation signal may be provided to mixer/demodulator 210 (e.g., matching the frequency and phase of the provided output signal from the MEMS via multiplexer 206). In some embodiments one or more circuit elements such as for compensating an offset or quadrature portion of MEMS gyroscope output may be switched into the circuit, for example, at the input terminals to C2V amplifier. Examples of switching and reset methodologies and related components are provided in U.S. patent application Ser. No. 17/680,637, filed on Feb. 25, 2022, and entitled “Round Robin Sensor Device for Processing Sensor Data,” U.S. patent application Ser. No. 17/345,778, filed on Jun. 11, 2021, and entitled “Sensor Output Digitizer,” and U.S. Pat. No. 10,608,656, filed on Dec. 13, 2018, and entitled “Sensing an External Stimulus Using a Group of Continuous-Time Nyquist Rate Analog-to-Digital Converters in a Round-Robin Manner,” each of which is hereby incorporated by reference in its entirety.

As is described herein, portions of the periodic gyroscope output signal may not be provided to the integrator during gyroscope guard band time intervals. Although such gyroscope guard band time intervals may be implemented at a variety of times, in an exemplary embodiment the gyroscope guard band time intervals may be implemented as centered at a zero-crossing of a Coriolis portion of the gyroscope output signal. Providing a gyroscope guard band at and about the Coriolis zero-crossing in this manner prevents demodulation to DC of harmonics (e.g., a second harmonic) of the gyroscope output signal and maximizes signal-to-noise ratio (SNR) of the system. Gyroscope guard bands may be “active” gyroscope guard bands that occur between transitions between gyroscope sense axes and “inactive” gyroscope guard bands that occur during a period of a gyroscope sense axis (e.g., during a zero-crossing during the period of the gyroscope sense axis).

In an embodiment, gyroscope measurement time intervals for processing the gyroscope output signal by the measurement circuitry (e.g., for amplification, demodulation, and integration) may be centered about peak transitions of the gyroscope output signal, such that each gyroscope axis is sensed during two time intervals (e.g., each associated with a peak transition) with an intervening inactive gyroscope guard band time interval between them (e.g., associated with a zero crossing between the peak transitions). Further, on transitions between gyroscope sense axes, additional gyroscope active guard bands may be implemented in a similar manner, such that an active gyroscope guard band precedes measurement for a gyroscope axis and an inactive gyroscope guard band is interposed within a sense period of each gyroscope axis. In some instances (e.g., at transitions between gyroscope sense axes where the gyroscope integration is not required to hold an output), the active gyroscope guard band may be utilized to provide one or more of the accelerometer outputs to the measurement and evaluation circuitry (e.g., with the accelerometer drive/carrier frequency being an integer multiple of the gyroscope drive/carrier frequency, allowing multiple accelerometer axes to be sensed during a gyroscope guard band time interval). Where an inactive gyroscope guard band is interposed within a period of sensed gyroscope axis, the measurement circuitry may be controlled (e.g., by control signals) such that the integrator does not accumulate any additional output voltage during the gyroscope guard band period, for example, by disconnecting the demodulator/mixer 210 from the C2V amplifier 208 output (switching elements not depicted in FIGS. 2, 4, and 6). In some implementations, the inactive gyroscope guard band may also be utilized to measure other signals such as accelerometer or other sensor output signals, for example, by providing the integrator output from the first measurement interval for analog-to-digital conversion and temporary storage, processing the other sensor output by the measurement and evaluation circuitry during the inactive guard band, and digitally combining the stored gyroscope output from the first measurement interval with the measured and evaluated gyroscope output form the second measurement interval.

The output of the integrator 212 is provided to the evaluation circuitry 215, which processes the analog output signal from integrator 212 to generate an output signal (e.g., a digital version of the analog output signal from integrator 212). In an embodiment, the evaluation circuitry 215 may be a successive approximation register (“SAR”) ADC 214, although in other embodiments other evaluation circuitry such as other ADC circuitry (e.g., a Nyquist ADC) may be utilized. In some embodiments, a high precision technique such as utilizing “Continuous Time Pipeline Analog-To-Digital Conversion” may be implemented within the measurement circuitry 205 and evaluation circuitry 215, for example, as described in U.S. patent application Ser. No. 18/240,514, filed Aug. 31, 2023, and incorporated by reference in its entirety herein. Depending on the circuitry and technique implemented by the evaluation circuitry 215, and the characteristics of the analog output signal being processed, the evaluation circuitry may include one or more stages where it acquires the analog output signal and one or more additional stages where it evaluates the analog output signal.

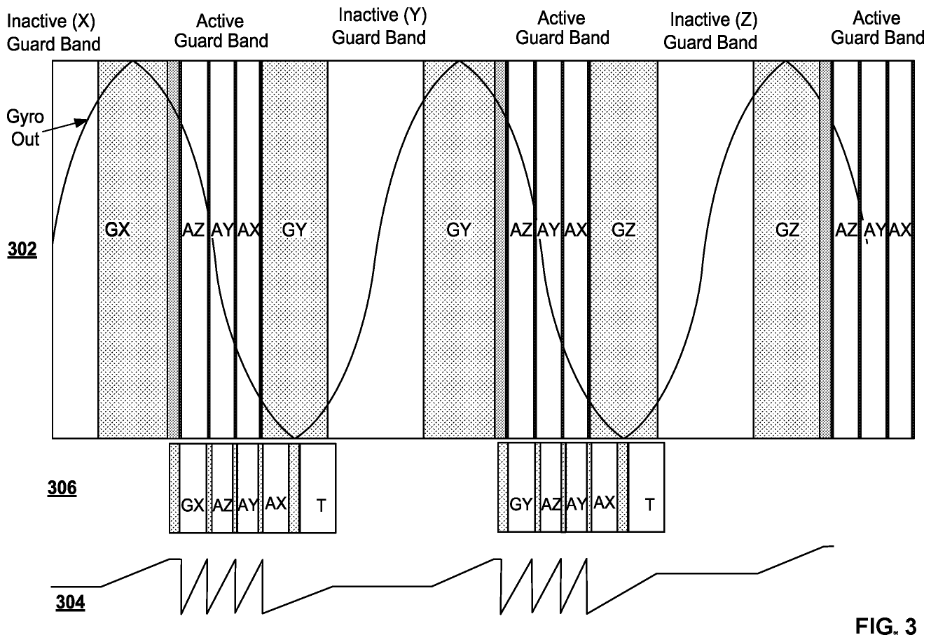

FIG. 3 depicts an exemplary timing diagram of measurement and evaluation stages for a six-axis round robin MEMS sensor in accordance with an embodiment of the present disclosure. Although a particular timing sequence is provided for a particular combination of MEMS sensors (e.g., three MEMS accelerometer axes and three MEMS gyroscope axes) and other sensors (e.g., temperature), other combinations of sensors may utilize the round-robin timing and processing techniques described herein. While particular frequencies are depicted for the sensors/axes of FIG. 3 and the signals are phase-aligned, it will be understood that the timing and processing described herein may be applied to other frequencies and relative phases, for example, by modifying signal measurement times, gyroscope guard bands, and ADC timing.

FIG. 3 depicts a timing diagram 302 for the timing of the measurement circuitry (e.g., measurement circuitry 205), a timing diagram 304 for the output of the integrator (e.g., integrator 212), and a timing diagram 306 for the timing of the evaluation circuitry (e.g., ADC 214). A gyroscope output signal is depicted in timing diagram 302 over the timing of measurement circuitry 205 and corresponds to the phase of each of the MEMS gyroscope output signals, which are phase-aligned. Within the timing diagram 302 for measurement circuitry 205, white portions correspond to gyroscope guard bands for the particular MEMS gyroscope axis being measured, with portions of the active gyroscope guard bands including a label AX, AY, or AZ corresponding measurement intervals for MEMS accelerometer outputs within the active gyroscope guard band. Dotted portions of the timing diagram 302 of measurement circuitry 205 correspond to MEMS gyroscope measurement intervals, and are labeled with GX, GY, or GZ to correspond to the MEMS gyroscope axis being measured. Gyroscope guard bands between the gyroscope measurement intervals for a particular axis are inactive gyroscope guard bands and are labeled (X), (Y), or (Z) in accordance with the gyroscope axis being measured about the inactive gyroscope guard bands. Although these gyroscope guard bands are labeled as “inactive” it will be understood that as described herein such inactive gyroscope guard bands may be utilized to perform other measurements and evaluations.

Dark gray portions of the timing diagram 302 of measurement circuitry 205 correspond to sampling intervals for the MEM gyroscope axis being measured, while thick black lines within the timing diagram 302 correspond to reset periods for the measurement circuitry 205, some of which occur during gyroscope guard bands. Within the timing diagram 304 for integrator 212, upward sloping portions correspond to times in which the MEMS sensor/axis being measured is being sampled and accumulated, flat portions correspond to times during which the current value is being held, and the signal returns to zero when resets occur. Within the timing diagram 306 for ADC 214, empty portions correspond to when the ADC is inactive and available to process other signals, dotted portions of timing diagram 306 correspond to acquisition intervals for the ADC 214, and white portions of timing diagram 306 correspond to evaluation intervals for ADC 214, with the MEMS sensor type, MEMS sensor axis, or other sensor type indicated by a label such as AX, AY, AZ, GX, GY, GZ, or T (e.g., for temperature).

Moving from left to right within timing diagram 302, the gyroscope output signal corresponding to the X-axis (e.g., based on the multiplexer 206 providing the x-axis gyroscope output signal 204x to the measurement circuitry) is crossing zero within the inactive (X) gyroscope guard band. Accordingly, the measurement circuitry is inactive and retains the current integrator 212 value from an earlier measurement interval portion for the gyroscope x-axis, as depicted by the corresponding flat portion of timing diagram 304. After a time interval for the inactive (X) gyroscope guard band, the measurement circuitry is reactivated, as shown by the GX-labeled dotted portion of the timing diagram 302 for measurement circuitry 205 and the corresponding positive slope at timing diagram 304 for integrator 212. At the end of the second GX measurement interval, the integrator value for the gyroscope x-axis is retained for a sampling interval of timing diagram 302, as is shown in timing diagram 304 by the integrator 212 retaining its value during the sampling interval. During the sampling interval for the gyroscope x-axis, as depicted at timing diagram 306, ADC 214 begins its acquisition of the integrator 212 output, and once the analog angular velocity signal output of integrator 212 is acquired, evaluates this output to determine the digital angular velocity signal during the portion of timing diagram 306 labeled “GX”.

Once the ADC 214 acquires the analog angular velocity signal as depicted prior to the portion of timing diagram 306 labeled “GX”, the measurement circuitry 205 can receive another signal for measurement. As is shown in FIG. 3, after acquisition by the ADC 212 is complete, the measurement circuitry 205 is reset (e.g., as depicted by the dark black line between “GX” and “AZ” in timing diagram 302), causing the integrator 212 output to return to zero as depicted in timing diagram 304. During the active gyroscope guard band during the transition between GX and GY measurement, and corresponding to the “AZ”-labeled portion of timing diagram 302 that follows the reset, the multiplexer 206 then provides the z-axis MEMS accelerometer output signal to the measurement circuitry 205, which corresponds to the positive sloping integrator 212 output depicted in timing diagram 304. By the conclusion of the evaluation interval for the x-axis gyroscope, the ADC 214 is able to acquire (e.g., dotted portion of timing diagram 306 between “GX” and “AZ”) and evaluate (e.g., the following portion of timing diagram 306 labeled “AZ”) the analog linear acceleration output of integrator 212 corresponding to the z-axis accelerometer output. This sequence of resetting the measurement circuit 205, generating the analog linear acceleration signal at integrator 212, and the ADC 214 acquiring and evaluating the analog linear acceleration signal to determine the digital linear acceleration signal for the accelerometer axis under evaluation, is repeated during the active gyroscope guard band during the transition between GX and GY measurement, for each of the accelerometer y-axis and accelerometer x-axis as depicted by the portions of timing diagram 302 labeled “AY” and “AZ”, the corresponding reset and upward sloping portions of timing diagram 304, and the acquisition periods and subsequent evaluation periods depicted with “AY” and “AZ” in timing diagram 306. As depicted in FIG. 3, based on the respective frequencies of the MEMS accelerometers and MEMS gyroscopes, evaluation of a full drive/carrier period of all three MEMS accelerometers can be performed during an active gyroscope guard band (e.g., zero-crossing) of the MEMS gyroscopes (e.g., during the transition between GX and GY measurement).

Referring back to timing diagram 306, after evaluation of the gyroscope x-axis and the accelerometer x, y, and z axes, the ADC 214 is inactive and available to process other signals. In the embodiment depicted in FIG. 3, a temperature sensor output (not depicted in FIG. 2) is also acquired and evaluated by the ADC 214 while ADC 214 is not processing MEMS sensor outputs. These inactive time intervals generally correspond to the measurement intervals for the gyroscope axes and gyroscope guard bands between those measurement intervals (e.g., during which acceleration is not being measured), and provide significant intervals for ADC 214 to process additional MEMS or other sensor signals.

As depicted in timing diagram 302 of FIG. 3, gyroscope guard bands can occur during measurement of a single gyroscope axis (inactive gyroscope guard bands) or between measurements of different axes (active gyroscope guard bands). For example, the active gyroscope guard bands during which acceleration measurements are performed in the embodiment of FIGS. 3, 5, and 7 occur between transitions to different gyroscope measurement axes. As depicted in FIG. 3, acceleration measurements are first performed after measurement of the gyroscope x-axis and before measurement of the gyroscope y-axis, and again after measurement of the gyroscope y-axis and before measurement of the gyroscope z-axis. An example of an inactive gyroscope guard band interposed between two measurement intervals for a single gyroscope axis is depicted in FIG. 3 for the gyroscope y-axis measurement. After measurement of the accelerometer x-axis, the measurement circuitry 205 is reset and multiplexer 206 provides the y-axis gyroscope output signal to the measurement circuit as depicted by “GY” in timing diagram 302. During an initial measurement interval the integrator accumulates the measured angular velocity for the y-axis gyroscope, as depicted by the positive sloping integrator 212 value in timing diagram 304. The measurement circuit is inactive during the inactive (Y) gyroscope guard band, which in turn corresponds to a zero crossing of the y-axis gyroscope output signal, although as described herein the integrator output may be evaluated and stored after the first measurement interval to allow other measurements during the inactive (Y) gyroscope guard band. Once the inactive (Y) gyroscope guard band is complete, integration of the y-axis gyroscope output signal continues as depicted in timing diagram 304 corresponding to the second “GY” measurement interval in timing diagram 302.

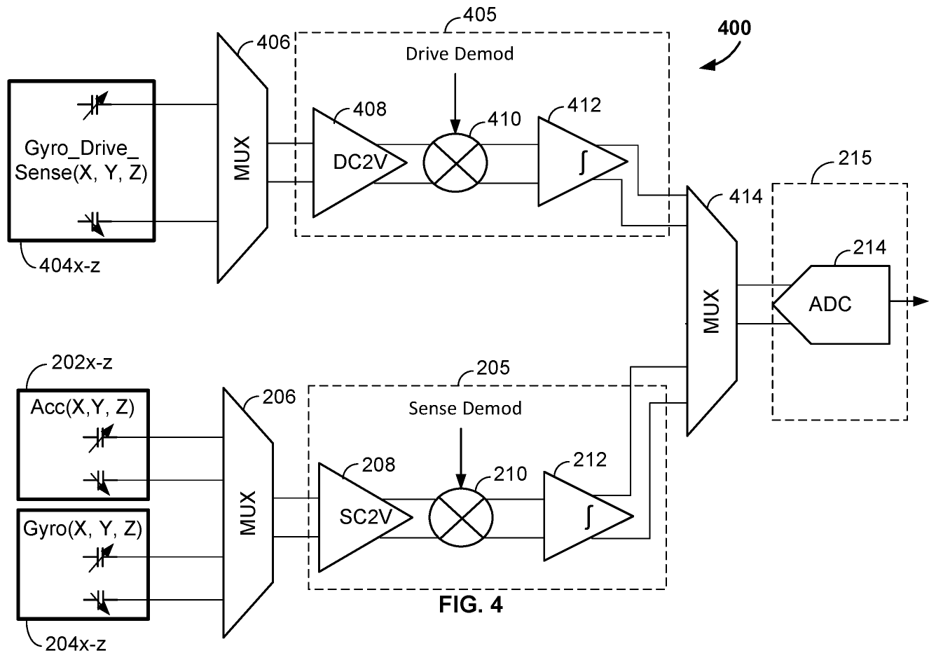

FIG. 4 depicts an exemplary six-axis round robin MEMS sensor with gyroscope drive sense measurement in accordance with an embodiment of the present disclosure. Although particular components are depicted and described in FIG. 4 it will be understood that components may be added, removed, substituted, or modified in accordance with the present disclosure. For example, the drawings and schematics depicted herein (e.g., FIGS. 2, 4, and 6) depict simplified versions of processing circuitry such as multiplexer 206, measurement circuitry 205, evaluation circuitry 215, sense capacitance-to-voltage (“SC2V”) amplifier 208, mixer/demodulator 210, integrator 212, and analog-to-digital converter (“ADC”) 214, multiplexer 406, measurement circuitry 405, drive sense capacitance-to-voltage (“DC2V”) amplifier 408, mixer/demodulator 410, integrator 412, and multiplexer 414, and it will be understood that each of these components may be configured in a variety of manners as is understood in the art, for example, with associated resistors, capacitors, filters, switches, and the like to provide for appropriate complex signal processing and filtering. Moreover, the operations performed by particular components of processing circuitry herein may similarly be performed by alternative circuitry or components known in the art.

As is depicted in FIG. 4, three axes of accelerometer sensing 202x-z correspond to the accelerometers of FIG. 2 (e.g., x-axis accelerometer 202x, y-axis accelerometer 202y, and z-axis accelerometer 202z) while three axes of gyroscope sensing 204x-z correspond to the gyroscopes of FIG. 2 (e.g., x-axis gyroscope 204x, y-axis gyroscope 204y, and z-axis gyroscope 204z). Other like-numbered components of FIG. 4 (e.g., multiplexer 206, measurement circuitry 205, and evaluation circuitry 215) correspond to the components described above with reference to FIG. 2 and are configured to operate in a similar manner. As described herein, the timing of control signals of these components in the context of the configuration of FIG. 4 may be modified, for example, to allow shared evaluation circuitry 215 (e.g., ADC 214) to process three axes of linear acceleration, three axes of angular velocity, and one or more axes of gyroscope drive sense in a round-robin fashion.

In the embodiment of FIG. 4, a drive sense system senses a drive motion associated with each of the gyroscope axes 204x-z, with MEMS x-axis drive sense 404x corresponding to a drive motion that couples to an angular rotation about the x-axis of x-axis gyroscope 204x, MEMS y-axis drive sense 404y corresponding to a drive motion that couples to an angular rotation about the y-axis of y-axis gyroscope 204y, and MEMS z-axis drive sense 404z corresponding to a drive motion that couples to an angular rotation about the z-axis of z-axis gyroscope 204z. In some embodiments (not depicted) multiple sense axes may be driven by a single drive motion, in which case fewer drive sense signals may be needed. Although drive sensing may be performed in a variety of manners, in the example depicted in FIG. 4 the drive sensing is performed based on capacitive sensing of motion of a driven mass for each of the axes relative to a fixed electrode. The driven mass may be a mass that is directly driven to impart the drive motion or a mass that is indirectly driven via springs, masses, and/or lever arms of the relevant spring-mass system, including the proof mass or other masses that impart a Coriolis motion on one or more the proof masses.

The relative timing of the MEMS drive sense 404x-z may be known based on the physical characteristics of the gyroscopes, e.g., as 90 degrees out-of-phase with the Coriolis outputs of the MEMS gyroscope axes 204x-z. Although a multiplexer 406 is depicted as selectively providing one of the outputs of the MEMS drive sense 404x-z, it will be understood that a variety of switching hardware and/or techniques may be used to selectively switch MEMS drive sense output signals (e.g., each a differential sense signal) to other processing circuitry. The timing of the multiplexer 406 selectively providing output signals to the processing circuitry is controlled such as a by a control signal (not depicted in FIG. 4) provided based on the timing described herein. For example, timing control of multiplexer 406 may be performed such that a period of each drive sense signal is sensed over a full period between like-sloping zero crossings, or in words, 90 degrees out of phase with the corresponding gyroscope sense axis.

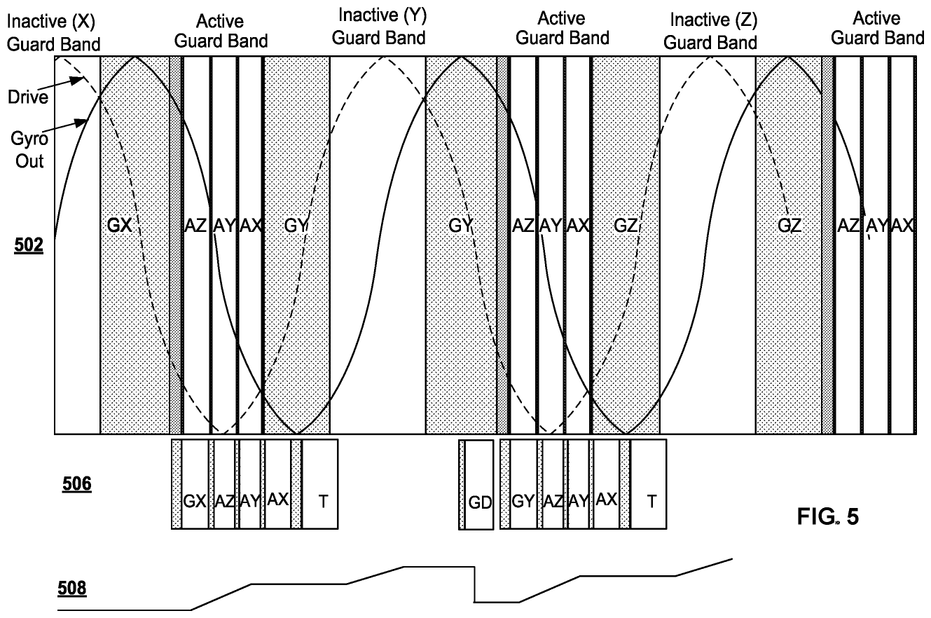

As with the Coriolis sense signals, in some embodiments the drive sense signals may be captured over a full period, with a gyroscope guard band adjacent to and at a zero crossing of the drive sense signals. Accordingly, sensing for a drive sense signal requires the same length period—offset by 90 degrees—as the Coriolis signal for measurement and integration. Although it may be possible to multiplex the drive sense signals with the Coriolis sense and linear acceleration signals (not shown in FIG. 4), doing so will limit how often either the Coriolis sense, the drive sense, or both may be measured because of both the length of the time periods and the phase shift of drive signals. Accordingly, the MEMS drive sense 404x-z outputs may be multiplexed only with each other and processed by a dedicated measurement circuitry 405. Because the evaluation stage executed by evaluation circuitry 215 requires substantially less time than the period of the Coriolis and drive sense signals, an analog gyroscope drive sense output generated by the measurement circuitry 415 can be interspersed within inactive times during the operation of the evaluation circuitry, as described in more detail with respect to FIG. 5.

Measurement circuitry 405 processes a received output signal from one of the MEMS drive sense axis outputs to generate an analog drive sense signal representative of the sensed drive sense output along one of the x-axis, y-axis, or z-axis. Although generating the analog drive sense signal may be performed in a variety of manners, as depicted in FIG. 4, measurement circuitry 405 includes drive sense C2V amplifier 408, demodulator 410, and integrator 412. Drive sense C2V amplifier 408 receives the differential drive sense output signal that is selectively output by multiplexer 406 and amplifies the signal. The amplified output of sense C2V amplifier is provided to mixer/demodulator 410 which applies a phase-aligned demodulation signal having the frequency of the drive sense signal being measured, for example, based on a known timing and frequency of the MEMS sensor type and axis being measured. The resulting demodulated output signal (e.g., corresponding to sensed drive motion of an axis of the MEMS gyroscope) is provided to integrator 412 which integrates the received signal over an appropriate time period (e.g., one or more periods of the underlying drive sense signal), with the integrated signal corresponding to the respective output signal (e.g., the analog drive sense signal associated with a particular gyroscope sense axis).

In the embodiment depicted in FIG. 4, multiplexer 414 multiplexes the analog drive sense signals with the analog linear acceleration signals and the analog angular velocity signals to be provided to the evaluation circuitry 215. In the example of FIG. 4, each of the analog output signals—e.g., each of the analog drive sense signals, analog linear acceleration signals, and analog angular velocity signals—is integrated over a predetermined time (e.g., a period of the associated drive or carrier signal). At the conclusion of the measurement (e.g., integration) time, the resulting analog signal is provided to evaluation circuitry 215 (e.g., ADC 214), sometimes after being held for an interval to allow the evaluation circuitry to become available. The amount of time required for the evaluation is significantly less than the time period required for integration of received signals, and thus, integrated analog outputs from multiple integrators (e.g., integrators 212 and 412) can be sequenced by multiplexer 414 such that during a single period of a MEMS gyroscope, both the drive sense and the Coriolis sense can be integrated and evaluated. Combined with the ability to integrate and evaluate all three MEMS accelerometer axis during an active gyroscope guard band of a MEMS gyroscope axis, during a single MEMS gyroscope period for one axis the drive sense for the axis, Coriolis sense for the axis, and acceleration sense for all 3 accelerometer axes can be determined. In addition, other sensed parameters (signal paths not depicted in FIG. 4) such as analog temperature signals may be provided to the evaluation circuitry 215 (e.g., via multiplexer 414).

FIG. 5 depicts exemplary timing diagrams of measurement and evaluation stages for a six-axis round robin MEMS sensor with drive sense measurement in accordance with an embodiment of the present disclosure. FIG. 5 depicts identical measurement and evaluation timing as FIG. 3, except that FIG. 5 also depicts a drive signal superimposed on the timing diagram 502, a timing diagram 508 for the output value of integrator 412 associated with measurement of the drive signal, and a timing diagram 506 that includes the ADC 214 acquisition and evaluation of the analog drive signal output from integrator 412. As is depicted in FIG. 5, the gyroscope drive signal is 90 degrees out of phase with the gyroscope output signal. As is depicted in timing diagram 508 (e.g., corresponding to the integrator 412 output value), integration of the gyroscope drive signal occurs during the gyroscope guard bands while the guard bands for the drive signal correspond to the Coriolis measurement intervals. As with the Coriolis integration, the drive signal integration occurs over two measurement intervals. The drive signal can then be evaluated by the ADC 214 (e.g., as depicted by portions of the timing diagram 506 labeled “GD”) while MEMS sensor evaluation is inactive, for example, prior to evaluation of the gyroscope axis corresponding to the measured drive signal.

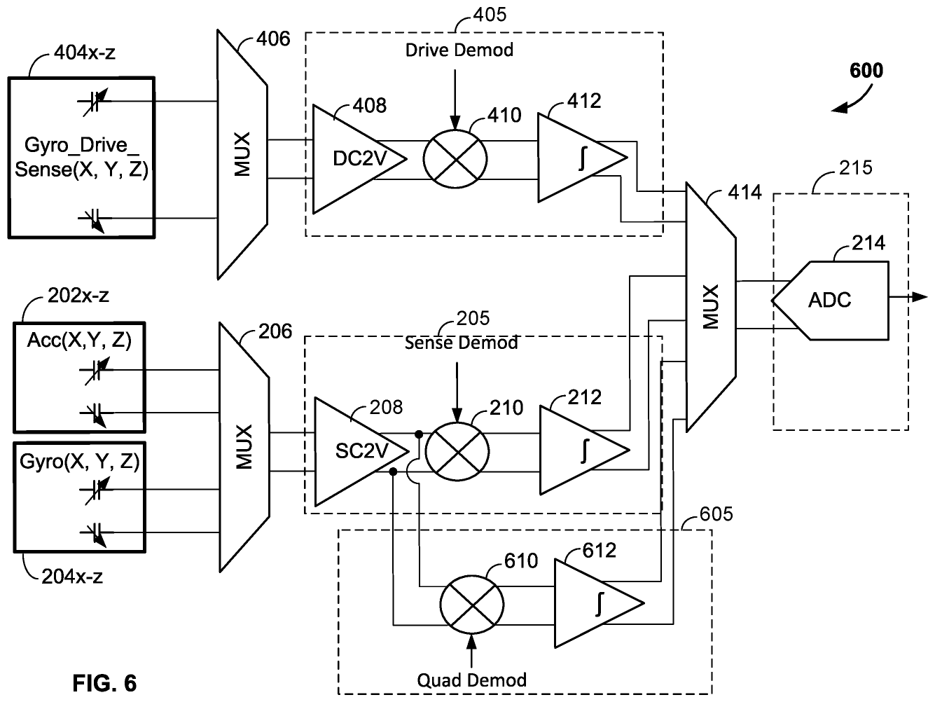

FIG. 6 depicts an exemplary six-axis round robin MEMS sensor with gyroscope drive sense and quadrature measurement in accordance with an embodiment of the present disclosure. Although particular components are depicted and described in FIG. 6, it will be understood that components may be added, removed, substituted, or modified in accordance with the present disclosure. For example, the drawings and schematics depicted herein (e.g., FIGS. 2, 4, and 6) depict simplified versions of processing circuitry such as multiplexer 206, measurement circuitry 205, evaluation circuitry 215, sense capacitance-to-voltage (“SC2V”) amplifier 208, mixer/demodulator 210, integrator 212, and analog-to-digital converter (“ADC”) 214, multiplexer 406, measurement circuitry 405, drive sense capacitance-to-voltage (“DC2V”) amplifier 408, mixer/demodulator 410, integrator 412, multiplexer 414, measurement circuitry 605, mixer/demodulator 610, and integrator 612, and it will be understood that each of these components may be configured in a variety of manners as is understood in the art, for example, with associated resistors, capacitors, filters, switches, and the like to provide for appropriate complex signal processing and filtering. Moreover, the operations performed by particular components of processing circuitry herein may similarly be performed by alternative circuitry or components known in the art.

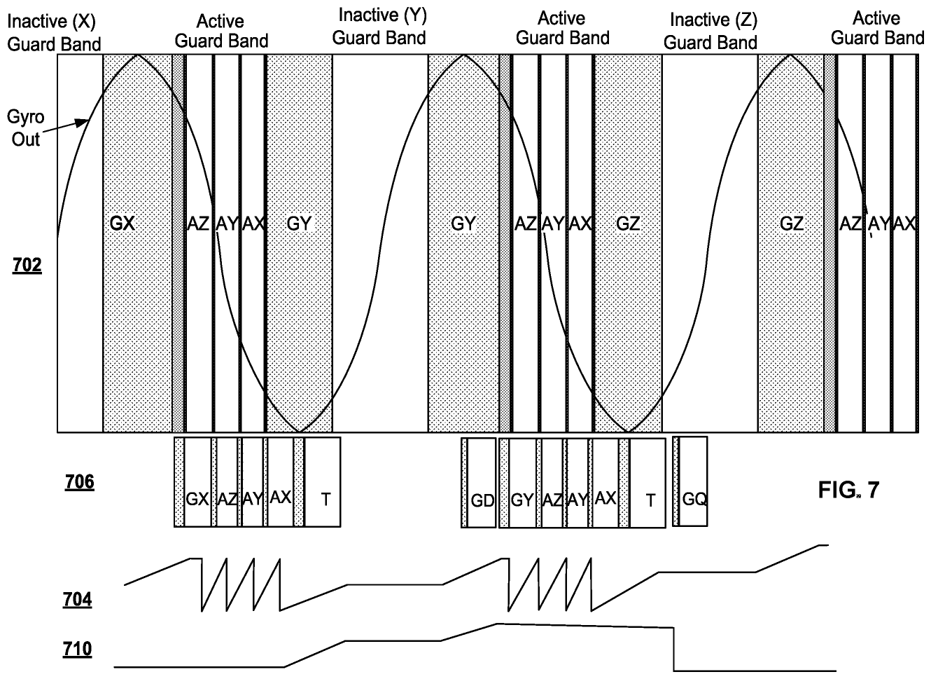

The components of FIG. 6 generally correspond to and operate in a similar manner to the components depicted and described with respect to FIG. 4, except that FIG. 6 also includes quadrature sense measurement circuitry 605. The quadrature portion of the amplified gyroscope output signal for a particular axis is extracted and isolated by demodulating that signal with a quadrature demodulation signal at mixer/demodulator 610. The quadrature demodulation signal has a frequency and phase that corresponds to a quadrature portion of the gyroscope output signal, for example, at the drive frequency and 90 degrees out of phase from the Coriolis portion of the gyroscope output signal. The demodulated quadrature portion of the gyroscope output signal for the axis being analyzed is then integrated as described herein (e.g., over a time such as a period of the quadrature signal with gyroscope guard bands at and about zero crossings of the quadrature portion) and selectively provided to the evaluation circuitry 215 (e.g., to ADC 214) in a predetermined sequence with the other signals under evaluation, as described herein and in more detail in FIG. 7.

Analysis of the quadrature portion of the gyroscope output signal may be useful in better extracting the Coriolis portion from the gyroscope output signal. For example, knowledge of characteristics of the quadrature signal may be utilized to modify signals such as drive signals provided to the MEMS gyroscope. As another example, the complex characteristics of the measurement circuit may be modified such as by switching capacitors of a capacitor bank into the receive signal path, for example, at an input node to C2V amplifier 208. Such modifications may reduce unwanted signal portions such as the quadrature signal itself or an offset that typically occurs at the output of a C2V amplifier due to quadrature. Round-robin processing of quadrature signal measurements may facilitate such processing with limited additional circuitry, and a large portion of the processing may be performed in the digital domain (additional circuitry and digital processing steps for quadrature and/or offset removal not depicted). Examples of use of dynamic quadrature and offset reduction, and associated circuitry and digital processing operations, are depicted and described in U.S. patent application Ser. No. 18/237,533, entitled “DYNAMIC CAPACITANCE-TO-VOLTAGE OFFSET CANCELLATION” and filed on Aug. 24, 2023, and U.S. patent application Ser. No. 18/483,661, entitled “GYROSCOPE QUADRATURE CANCELLATION” and filed on Oct. 10, 2023, both of which are incorporated by reference herein in their entirety.

FIG. 7 depicts exemplary timing diagrams of measurement and evaluation stages for a six-axis round robin MEMS sensor with drive sense measurement and quadrature measurement in accordance with an embodiment of the present disclosure. FIG. 7 depicts identical measurement and evaluation timing as FIGS. 3 and 5 (e.g., as depicted in timing diagrams 702 and 704), except that FIG. 7 also depicts timing diagram 710 depicting timing for the output value of integrator 612 associated with measurement of the quadrature signal, and includes within timing diagram 706 timing for the acquisition and evaluation (e.g., by ADC 214) of the analog quadrature signal output from integrator 612. Although measures are typically taken to reduce or compensate for a quadrature portion of a gyroscope output signal, a gyroscope output signal is a complex signal having Coriolis and quadrature components. The quadrature measurement is performed at the same time as the Coriolis measurement to identify the presence of quadrature on the gyroscope output signal. Accordingly, as depicted by timing diagram 710 in FIG. 7, the quadrature integrator 612 accumulates the quadrature output (e.g., provided by demodulator 610) during measurement intervals and is inactive to hold the accumulated value during interposing inactive gyroscope guard bands (e.g., as depicted in FIG. 7, during the inactive (Y) gyroscope guard band). In the embodiment depicted in FIG. 7, and because the quadrature integration is coordinated with the Coriolis integration, the analog quadrature signal output from the integrator 612 is held until the ADC 214 is available as depicted in timing diagram 706, as depicted by the acquisition and integration intervals for “GQ”. In some embodiments, the relative timing and usage of the ADC 214 may be modified to allow for faster evaluation of the quadrature signal, for example, by periodically skipping acceleration signal evaluation to prioritize quadrature evaluation.

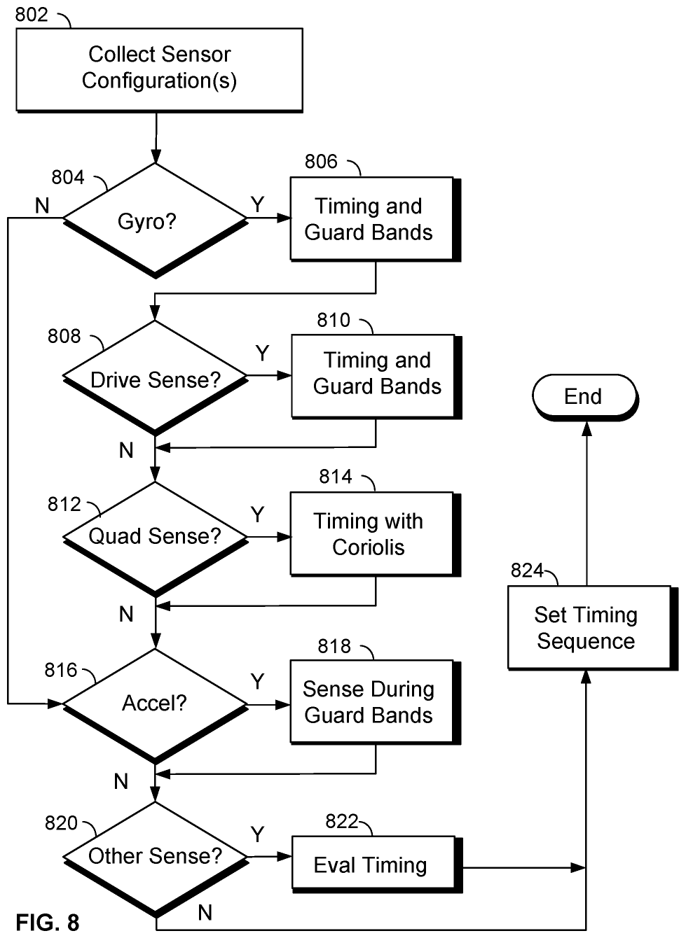

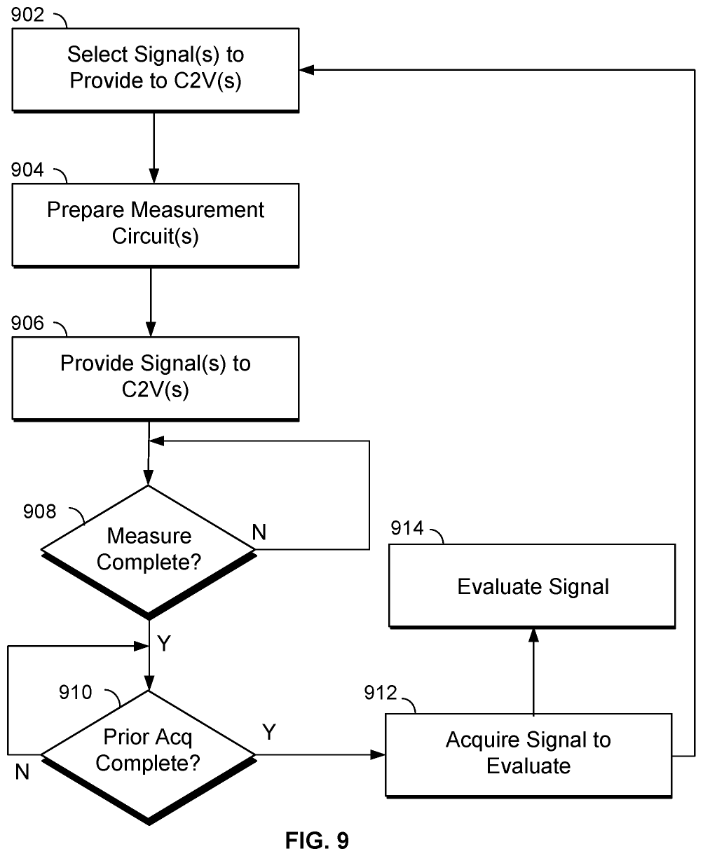

FIGS. 8 and 9 depict exemplary steps of round-robin MEMS sensing in accordance with an embodiment of the present disclosure. Although particular steps are depicted in a certain order for FIGS. 8 and 9, steps may be removed, modified, or substituted, and additional steps may be added in certain embodiments, and in some embodiments, the order of certain steps may be modified.

FIG. 8 depicts exemplary steps of determining a timing sequence for measurement and evaluation phases of a round robin MEMS sensor in accordance with an embodiment of the present disclosure. At step 802, the sensor configuration for the particular device is collected. For example, as described herein, it may be determined which sensors, sensor axes, and other parameters are to be measured and evaluated, including MEMS gyroscope axes, MEMS accelerometer axes, MEMS gyroscope drive sense, and MEMS gyroscope quadrature sense. Once the sensor configuration is established, processing may continue to step 804.

At step 804 it may be determined whether a MEMS gyroscope is included in the device configuration. If there is no gyroscope in the device configuration, processing continues to step 816. If there is a gyroscope in the device configuration, processing continues to step 806. At step 806, the timing of the measurement intervals and gyroscope guard band intervals is established based on the number of gyroscope axes, relative frequencies, relative phases, and required gyroscope guard band width. For example, the active gyroscope guard band width may be selected to be long enough to accommodate the number of accelerometer axes to be converted (e.g., based on the drive period of the accelerometer axes), the number of cycles of evaluation processing (e.g., pipeline/SAR ADC cycles need to resolve the most significant bits of the previous gyroscope conversion), as well allocation of time to reset the C2V amplifier before each measurement axis. As another example, in order to reject even harmonics, the inactive gyroscope guard band (e.g., in the middle of a gyroscope measurement time) should have an equal width as the active gyroscope guard band (e.g., for accelerometer measurement, between gyroscope axes). Once this timing is established, processing may continue to step 808.

At step 806 it may be determined whether MEMS gyroscope drive sensing is to be determined with shared evaluation circuitry. If drive sense will not be evaluated with shared evaluation circuitry, processing may continue to step 812. If drive sense will be evaluated with shared evaluation circuitry, processing may continue to step 810. At step 810, the timing and gyroscope guard bands of the drive sense may be determined. For example, in some multi-axis gyroscopes a single drive system may drive the masses for multiple sense axes. Accordingly, it may only be necessary to accommodate measurement and evaluation of a single drive sense output. In other embodiments, each gyroscope sense axis may have an independent drive motion, requiring allocation of ADC time for evaluation of multiple drive axes. Once the timing of the drive sense is determined, processing may continue to step 812.

At step 812 it may be determined whether MEMS quadrature sensing is to be determined with shared circuitry. If quadrature sense will not be measured and evaluated with shared circuitry, processing may continue to step 816. If quadrature sense will be evaluated with shared circuitry, processing may continue to step 814. At step 814, the timing of the quadrature sense may be determined. For example, where quadrature sense is used for compensation, it may not be necessary to perform quadrature sensing with every Coriolis sense cycle for the axis under evaluation, allowing more ADC time to be dedicated to evaluation of other analog outputs. Once the timing of the quadrature sense is determined, processing may continue to step 816.

At step 816 it may be determined whether MEMS accelerometers are to be measured and evaluated with shared circuitry. If accelerometers will not be measured and evaluated with shared circuitry, processing may continue to step 820. If accelerometer outputs will be measured and evaluated with shared circuitry, processing may continue to step 818. At step 818, the accelerometer parameters such as number of axes, drive/carrier frequency, and phase may be evaluated in comparison to the timing of other signals such as gyroscope output signals. Based on this evaluation, it may be possible to measure and evaluate the accelerometer outputs during active and/or inactive gyroscope guard bands. Once the timing of the accelerometer measurement and evaluation is determined, processing may continue to step 820.

At step 820 it may be determined whether there are any other analog values to evaluate such as with a shared ADC. If other values will not be evaluated processing may continue to step 824. If other values are to be evaluated, processing may continue to step 822. At step 822, the available evaluation circuitry timing may be compared to the parameters for the additional sensor or sensors, such as required acquisition time, required measurement frequency, and the like to establish timing for evaluation. Once this timing has been established, processing may continue at step 824.

At step 824, the timing of the control and operation of the system components is set, such as by coordinating multiplexing of signals, active gyroscope guard bands, inactive gyroscope guard bands, measurement intervals, resets, inactive intervals, acquisition intervals, and evaluation intervals as described herein. Once the selection of the control sequence for the timing of the system is completed, the processing may end.

FIG. 9 depicts exemplary steps of operating a round robin MEMS sensor in accordance with an embodiment of the present disclosure. Processing begins at step 902, in which the next signal to provide to the C2V amplifier is determined. As described herein, output signals from MEMS sensors are provided (e.g., via a multiplexer) to a C2V amplifier of measurement circuitry in a predetermined sequence. Accordingly, at step 902 that next signal is identified in accordance with that sequence. Processing then continues to step 904.

At step 904, the measurement circuit may be prepared for the MEMS output signal selected at step 904. For example, after the previous analog output value (e.g., from an integrator of the measurement circuitry) has been acquired (e.g., by an ADC of evaluation circuitry), the measurement circuitry may be reset such as by resetting the C2V amplifier and integrator, and selecting the appropriate demodulation signal. Once the measurement circuitry is prepared, processing may continue to step 906.

At step 906, at the selected MEMS output signals is provided to the prepared measurement circuitry. The MEMS output signals are then measured and integrated as described herein, for example, with appropriate gyroscope guard bands for gyroscope measurement and integration. Other related signals such as quadrature and drive signals may also be processed by measurement circuitry in parallel with the MEMS sensor output, as described herein. Processing may then continue to step 908.

At step 908, it may be determined whether the measurement of the selected MEMS sensor output is complete. For example, each sensor may be measured and integrated over a predetermined time period such as a period of the output signal. Once the measurement is complete and the integrator output corresponds to the analog output signal for the MEMS sensor axis being measured, processing may continue to step 910.

At step 910, it may be determined whether the previously measured and acquired MEMS output signal or other sensor output (e.g., drive signal, quadrature signal, temperature signal) has been acquired. If not, the measurement circuitry may continue to hold the integrator output value such as by inactivating the measurement input to the integrator. Once the acquisition of the prior signal is complete, processing may continue to step 912.

At step 912, the evaluation circuitry may acquire the analog output signal for the MEMS sensor axis being measured. Processing may then continue in parallel to step 914, at which the acquired signal is evaluated, and step 902, at which the next sensor axis for measurement is selected. In this manner, the previously measured sensor axis can be evaluated while another sensor axis is measured.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A method for processing microelectromechanical system (MEMS) sensor outputs from multiple MEMS sensor types on shared processing circuitry, comprising:
receiving, by a measurement circuit during at least some of an active gyroscope guard band interval, an accelerometer output signal corresponding to movement of an accelerometer proof mass of a MEMS accelerometer;
generating, by the measurement circuit during the active gyroscope guard band interval based on the received accelerometer output signal, an analog linear acceleration signal;
receiving, by an evaluation circuit during a portion of the active gyroscope guard band interval, the analog linear acceleration signal;
determining, by the evaluation circuit, a digital linear acceleration signal based on the received analog linear acceleration signal;
receiving, by the measurement circuit during a first gyroscope measurement interval after the active gyroscope guard band interval, a gyroscope output signal corresponding to movement of a gyroscope proof mass of a MEMS gyroscope;
providing, to the measurement circuit during an inactive gyroscope guard band interval after the first gyroscope measurement interval, a gyroscope guard band signal that does not modify an analog angular velocity signal of the measurement circuit during the inactive gyroscope guard band interval;
receiving, by the measurement circuit during a second gyroscope measurement interval after the inactive gyroscope guard band interval, the gyroscope output signal;
generating, by the measurement circuit based on the gyroscope output signal received during the first and second gyroscope measurement intervals, the analog angular velocity signal;
receiving, by the evaluation circuit during a portion of the second gyroscope measurement interval, the analog angular velocity signal; and
determining, by the evaluation circuit, a digital angular velocity signal based on the received analog angular velocity signal.

2. The method of claim 1, further comprising resetting the measurement circuit during a reset interval between the active gyroscope guard band interval and the first gyroscope measurement interval.

3. The method of claim 1, wherein the portion of the active gyroscope guard band interval corresponds to a sampling interval for the evaluation circuit to sample the analog linear acceleration signal.

4. The method of claim 1, wherein the active gyroscope guard band interval is a same amount of time as the inactive gyroscope guard band interval, and wherein the active gyroscope guard band interval provides an additional gyroscope guard band for the analog angular velocity signal.

5. The method of claim 4, wherein the portion of the active gyroscope guard band interval comprises a second portion, and wherein the analog linear acceleration signal comprises an integration of the accelerometer output signal over a first portion of the active gyroscope guard band interval prior to the second portion.

6. The method of claim 4, wherein the active gyroscope guard band interval includes a first zero crossing of the gyroscope output signal and wherein the inactive gyroscope guard band interval includes a next zero crossing of the gyroscope output signal.

7. The method of claim 6, wherein the first gyroscope measurement interval includes a first peak transition of the gyroscope output signal and the second gyroscope measurement interval includes a second peak transition of the gyroscope output signal.

8. The method of claim 7, wherein the analog angular velocity signal comprises an integration of the analog angular velocity signal over the first gyroscope measurement interval and the second gyroscope measurement interval.

9. The method of claim 8, wherein the integration of the angular velocity signal is not performed during the active gyroscope guard band interval or the inactive gyroscope guard band interval.

10. The method of claim 9, wherein not performing the integration during the active gyroscope guard band interval or the inactive gyroscope guard band interval prevents demodulation to DC of a second harmonic of the gyroscope output signal.

11. The method of claim 1, wherein the active gyroscope guard band interval comprises a first sub-interval during which the accelerometer output signal is not received, a second sub-interval during which the accelerometer output signal for a first accelerometer axis is received, a third sub-interval during which the accelerometer output signal for a second accelerometer axis is received, and a fourth sub-interval during which the accelerometer output signal for a third accelerometer axis is received.

12. The method of claim 1, wherein the measurement circuit comprises a capacitance-to-voltage (“C2V”) amplifier and an integrator, and wherein both the accelerometer output signal and the gyroscope output signal are processed by the C2V amplifier and the integrator.

13. The method of claim 12, wherein the measurement circuit further comprises a demodulator, and wherein both the accelerometer output signal and the gyroscope output signal are processed by the demodulator.

14. The method of claim 12, further comprising:
switching, by a multiplexer located between the MEMS accelerometer and the measurement circuit, the accelerometer output signal to selectively connect each of a plurality of accelerometer axes to an input of the C2V amplifier during the active gyroscope guard band interval; and
switching, by the multiplexer which is located between the MEMS gyroscope and the measurement circuit, the gyroscope output signal for one axis of the MEMS gyroscope to connect to the input of the C2V amplifier during the first gyroscope measurement interval and the second gyroscope measurement interval.

15. The method of claim 1, wherein the evaluation circuit comprises an analog-to-digital converter (“ADC”) coupled to an output of the measurement circuit, and wherein both the analog linear acceleration signal and the analog angular velocity signal are processed by the ADC.

16. The method of claim 15, further comprising:
sampling, by the ADC during the portion of the active gyroscope guard band interval, the analog linear acceleration signal;
digitizing, by the ADC, the sampled analog linear acceleration signal to generate the digital linear acceleration signal;
sampling, by the ADC during the portion of the second gyroscope measurement interval, the analog angular velocity signal; and
digitizing, by the ADC, the sampled analog angular velocity signal to generate the digital angular velocity signal.

17. The method of claim 16, wherein the ADC comprises a successive approximation register (“SAR”) ADC or a Nyquist ADC.

18. The method of claim 1, further comprising:
receiving, by a second measurement circuit during the active gyroscope guard band interval and the inactive gyroscope guard band interval, a gyroscope drive sense signal;
generating, by the second measurement circuit, an analog drive sense signal based on the received gyroscope drive sense signal; and
determining, by the evaluation circuit during the second gyroscope measurement interval, a digital drive sense signal based on the analog drive sense signal.

19. The method of claim 1, further comprising:
receiving, by a second measurement circuit during the first gyroscope measurement interval and the second gyroscope measurement interval, the gyroscope output signal;
isolating, by the second measurement circuit during the first gyroscope measurement interval and the second gyroscope measurement interval, a quadrature portion of the gyroscope output signal;
generating, by the second measurement circuit based on the isolated quadrature portion of the gyroscope output signal during the first gyroscope measurement interval and the second gyroscope measurement interval, an analog quadrature signal; and
determining, by the evaluation circuit during a next subsequent inactive gyroscope guard band interval after the second gyroscope measurement interval, a digital quadrature compensation signal based on the analog quadrature signal.

20. A method for processing microelectromechanical system (MEMS) sensor outputs from a 3-axis MEMS accelerometer and a 3-axis MEMS gyroscope on shared processing circuitry, comprising:
receiving, by a measurement circuit during a first portion of an active gyroscope guard band interval, a first accelerometer output signal corresponding to movement of a first accelerometer proof mass of a MEMS accelerometer along a first axis;
generating, by the measurement circuit during the first portion of the active gyroscope guard band interval based on the received first accelerometer output signal, a first analog linear acceleration signal;
receiving, by an evaluation circuit during part of the first portion of the active gyroscope guard band interval, the first analog linear acceleration signal;
determining, by the evaluation circuit, a first digital linear acceleration signal from the first analog linear acceleration signal;
receiving, by the measurement circuit during a second portion of the active gyroscope guard band interval, a second accelerometer output signal corresponding to movement of a second accelerometer proof mass of the MEMS accelerometer along a second axis;
generating, by the measurement circuit during the second portion of the active gyroscope guard band interval based on the received second accelerometer output signal, a second analog linear acceleration signal;
receiving, by the evaluation circuit during part of the second portion of the active gyroscope guard band interval, the second analog linear acceleration signal;
determining, by the evaluation circuit, a second digital linear acceleration signal from the second analog linear acceleration signal;
receiving, by the measurement circuit during a third portion of the active gyroscope guard band interval, a third accelerometer output signal corresponding to movement of a third accelerometer proof mass of the MEMS accelerometer along a third axis;
generating, by the measurement circuit during the third portion of the active gyroscope guard band interval based on the received third accelerometer output signal, a third analog linear acceleration signal;
receiving, by the evaluation circuit during part of the third portion of the active gyroscope guard band interval, the third analog linear acceleration signal;
determining, by the evaluation circuit, a third digital linear acceleration signal from the third analog linear acceleration signal;
receiving, by the measurement circuit during a first gyroscope measurement interval after the active gyroscope guard band interval, a gyroscope output signal corresponding to movement of a gyroscope proof mass of a first axis of a MEMS gyroscope;
providing, to the measurement circuit during an inactive gyroscope guard band interval after the first gyroscope measurement interval, a gyroscope guard band signal that does not modify an analog angular velocity signal of the measurement circuit inactive gyroscope guard band interval, wherein the active gyroscope guard band interval is a same amount of time as the inactive gyroscope guard band interval;
receiving, by the measurement circuit during a second gyroscope measurement interval after the inactive gyroscope guard band interval, the gyroscope output signal;
generating, by the measurement circuit based on the gyroscope output signal received during the first and second gyroscope measurement intervals, the analog angular velocity signal;
receiving, by the evaluation circuit during a portion of the second gyroscope measurement interval, the analog angular velocity signal; and
determining, by the evaluation circuit, a digital angular velocity signal based on the received analog angular velocity signal.

21. A method for processing microelectromechanical system (MEMS) sensor outputs from a MEMS gyroscope and at least one other MEMS sensor on shared processing circuitry, comprising:
receiving, during a first gyroscope measurement interval, a gyroscope output signal corresponding to movement of a gyroscope proof mass, wherein the first gyroscope measurement interval includes a first peak transition during a period of the gyroscope output signal;
receiving, during an inactive gyroscope guard band interval following the first gyroscope measurement interval, a first guard signal, wherein the inactive gyroscope guard band interval includes a first zero crossing during the period of the gyroscope output signal;
receiving, during a second gyroscope measurement interval following the inactive gyroscope guard band interval, the gyroscope output signal, wherein the second gyroscope measurement interval includes a second peak transition during the period of the gyroscope output signal;
receiving, during an active gyroscope guard band interval following the second gyroscope measurement interval, an output signal of the at least one other MEMS sensor, wherein the active gyroscope guard band interval includes a second zero crossing during the period of the gyroscope output signal;
determining, based on the received gyroscope output signal during the first gyroscope measurement interval and the second gyroscope measurement interval, an angular velocity of the MEMS gyroscope; and
determining, based on the output signal of the at least one other MEMS sensor during a portion of the active guard band interval, an output value for the at least one other MEMS sensor.
